(19) United States
(12) Patent Application Publication
(10) Pub. No.: US 2016/0177845 A1
(43) Pub. Date: Jun. 23, 2016

(54) POWER PLANT USING TWO FUELS, INCLUDING ONE FUEL WITH A HIGH GELATION TEMPERATURE

(71) Applicant: AIRBUS HELICOPTERS, Marignane (FR)

(72) Inventor: Frederic DYRLA, Bouc Bel Air (FR)

(21) Appl. No.: 14/580,883

(22) Filed: Dec. 23, 2014

(51) Int. Cl. F02D 33/00; F02M 31/14; F02M 37/04; B64D 37/30

(52) U.S. Cl. CPC F02D 33/006; B64D 37/30; F02M 31/14; F02M 37/04

(57) ABSTRACT

The present invention relates to a fuel supply device for a heat engine intended for a rotary-wing aircraft, which feed device includes first and second reservoirs respectively containing first and second fuels suitable for feeding the heat engine. The second fuel is heated by passing through a heat exchanger, and then passes through a return valve positioned beyond the heat exchanger. The return valve is driven as a function of the temperature of the second fuel in order to direct the second fuel to the second reservoir when the temperature of the second fuel is lower than or equal to the setpoint temperature Tc, and to the heat engine when the temperature of the second fuel is higher than the setpoint temperature Tc.

### BACKGROUND OF THE INVENTION

(1) Field of the Invention

The present invention lies within the domain of heat engines, and, more specifically, within the domain of fuel supply devices for these heat engines.

The present invention relates to a fuel supply device for a heat engine. This heat engine may be fed by a first fuel that is preferably used only for the start-up of this heat engine and by a second fuel that has a high gelation temperature.

The present invention also relates to a power plant that notably includes at least one heat engine and at least one such fuel supply device for a heat engine, and further relates to a rotary-wing aircraft equipped with such a power plant.

(2) Description of Related Art

The proper operation of a heat engine is linked to the characteristics of the fuel or fuels that are used. In particular, the temperature at which a fuel starts to solidify—that is, the temperature at which this fuel, in the liquid state, starts to solidify—has direct effects on the operation of the heat engine.

Indeed, below a certain temperature, which can be referred to as the “gelation temperature”, it is possible to observe, in any fuel in the liquid state, the appearance of solid particles of this fuel when it starts to solidify. These particles can then clog the filters of this heat engine, increase the pressure losses, thereby interfering with its operation, or even causing it to halt.

Furthermore, the viscosity of a fuel decreases with its temperature. In fact, high viscosities, which can also be problematic for a heat engine, are thus encountered at low temperatures.

Thus, the operating domain of a heat engine—such as, for example, its start-up or its cruising flight—is limited at low temperatures, notably by this gelation temperature.

The phrase “low temperatures” is understood as referring to temperatures below 0° C.

Conversely, it can be noted that a high temperature of the fuel upon its injection into the combustion chamber allows the consumption by the heat engine to be reduced.

Thus, a pre-heater may allow a fuel to be heated before it is injected into a heat engine, through the use, for example, of a hot fluid, as described in document CA1233713.

Document US2011/0114068 describes a heat engine that can be fed by two fuels using the same conduit and the same injector. A first fuel is used for the start-up of the motor, while the second fuel replaces the first fuel when the motor is sufficiently hot. The first fuel is more volatile than the second fuel and thereby facilitates the start-up of the heat engine, especially at a low temperature.

Similarly, certain turbo motors are known to include a motor-oil/fuel exchanger that makes it possible primarily to cool this oil, thereby ensuring proper lubrication of the motor. Secondarily, this exchanger makes it possible to heat the fuel slightly and thereby obtain a reduction in consumption.

Furthermore, document US2012/0260666 describes a system that allows the combustion of two fuels, and, more specifically, of gases such as natural gas and a synthetic gas. Two conduits respectively direct the two fuels to the combustion chamber of the system, while a third conduit makes it possible to inject one of the two fuels into the combustion chamber through a set of openings. Thus, this system makes it possible to reduce the emissions of oxides of carbon (COx) and of oxides of nitrogen (NOx).

Document U.S. Pat. No. 7,712,451 is also known, which describes a system having multiple injectors and multiple fuels for an internal combustion engine. The injectors are located, on the one hand, at the entrance of the combustion chamber and, on the other hand, directly inside the combustion chamber. More specifically, the system uses two different fuels, which, on the one hand, may be an alternative fuel such as ethanol, hydrogen, or natural gas, and, on the other hand, may be a fossil fuel such as diesel fuel or gasoline. Each injector may inject one or the other of the two fuels and thereby make it possible to obtain a mixture of these two fuels in the combustion chamber, in order to reduce the noise and knocking of this thermal engine and to improve its performance.

Furthermore, document AT010064 describes a device for the distribution of at least two fuels in alternation in order to supply a heat engine. This device notably includes two reservoirs and a heat exchanger to heat one of the fuels by means of a cooling liquid used to cool the heat engine.

Document FR2902147 is also known, which describes a device for supplying a diesel motor with two fuels. Accordingly, the motor is fed by a first fuel (diesel fuel) upon start-up and when stopping, and by a second fuel (a vegetable oil) as soon as the temperature of the motor permits it, with this second fuel passing through heating means prior to its injection into the motor.

Moreover, document JP2004/027896 describes a power production plant that includes an electrical generator that is fed by two different fuels and a heat exchanger in order to heat one of the fuels by means of the thermal energy released by the electrical generator.

Last, documents US2011/0101166 et US2007/0240687 describe devices that use a plurality of different fuels.

Furthermore, in the specific case of rotary-wing aircraft, the operating conditions may vary during the course of the flight, for example, with the temperature falling with the altitude of the aircraft. The environment in which an aircraft operates may also be diversified, notably in terms of temperature.

In order to prevent the occurrence of problems linked to these diversified in changing conditions, the regulations may impose the use of fuels that have a very low gelation temperature (for example, below −40° C.) in order to ensure safe flights over broad temperature ranges.

However, such a regulation is not compatible with effective and economical use of alternative fuels, such as biofuels or fuels based on coal or natural gas.

The term “biofuels” is understood as referring to so-called “ecological” fuels, such as fuels obtained, for example, from biomass. The production yield of these biofuels may be linked to their gelation temperatures. Indeed, these yields are high when the ratio of biomass converted into biofuel is substantial. Notably, such yields may be obtained at high gelation temperatures, for example, on the order of 0° C.

Similarly, alternative fuels based on coal or natural gas may have substantial production yields when their gelation temperature is high, for example, on the order of 0° C.

Conversely, good characteristics in the cold (that is, at low temperatures) are obtained in exchange for low yields, and thus at high production costs for these alternative fuels.

Consequently, such alternative fuels are little used, being used almost exclusively for test flights and over very limited temperature ranges, for which their production costs are advantageous.

Furthermore, the gelation temperature of these alternative fuels may be lowered, thanks to the addition of additives that make it possible to expand their use in the cold, that is, at low temperatures. Conversely, the addition of these additives increases the cost of these alternative fuels and entails high costs for the qualification of the fuel/additive mixtures.

Thus, the purpose of the present invention is to propose a fuel supply device for a heat engine that makes it possible to overcome the above-mentioned limitations and to allow the use of alternative fuels that have a high gelation temperature, notably, biofuels or fuels based on coal or natural gas.

### BRIEF SUMMARY OF THE INVENTION

According to the invention, a fuel supply device for a heat engine includes two separate reservoirs, two feed pumps, and two feed conduits. A first reservoir contains a first fuel and a second reservoir contains a second fuel. The first and second reservoirs communicate with a feed housing of the heat engine by means, respectively, of a first and second feed conduit. The first feed pump is positioned between the first reservoir and the first feed conduit, while the second feed pump is positioned between the second reservoir and the second feed conduit. Thus, each fuel is able to feed a feed housing, with the feed housing allowing the injection of the fuel into the heat engine.

The first and second feed conduits may be linked directly to the feed housing. The first and second feed conduits are preferably rejoined to form a final conduit, with this final conduit feeding the feed housing.

This device is notable in that a heat exchanger is located between the second feed pump and the second feed conduit. Thus, the second fuel passes through the heat exchanger upon exiting from the second feed pump, thereby making it possible to heat the second fuel before it reaches the second feed conduit.

Thus, the feed housing of the heat engine may be fed, on the one hand, directly by the first fuel by means of the first feed pump and the first feed conduit, and, on the other hand, by the second fuel by means of the second feed pump and the second feed conduit, with this second fuel being capable of being heated by passing through the heat exchanger.

The first fuel, which directly feeds the feed housing, should allow the heat engine to operate regardless of the temperature conditions. This first fuel may have a very low gelation temperature (for example, lower than or equal to −40° C.) and may serve as a start-up fuel that allows the heat engine to be started under very low temperature conditions.

The second fuel may be heated by passing through the heat exchanger before feeding the feed housing and then the heat engine. Thus, this second fuel may have a higher gelation temperature than the first fuel, for example, higher than or equal to 0° C., with the heat exchanger allowing the second fuel to reach a temperature that is higher than this gelation temperature. The heat exchanger preferably uses part of the thermal energy that is available as a result of the operation of the heat engine.

The second fuel, after it has reached a sufficient temperature (that is, a temperature that is higher than its gelation temperature), makes it possible to feed the feed housing and then the heat engine with no risk of a malfunction of this heat engine. This second fuel then replaces the first fuel in order to feed the heat engine.

The second fuel may be an alternative fuel, such as a biofuel obtained from biomass (for example, from algae). The second fuel may also be an alternative fuel based on coal or natural gas.

The use of this second fuel advantageously makes it possible, on the one hand, to reduce pollutant emissions, and, on the other hand, to reduce the overall carbon footprint of this heat engine during its operation. The term “carbon footprint” is understood as referring to the carbon dioxide (CO2) emissions released during the full cycle of the second fuel (that is, from its production up through its combustion in the heat engine). Furthermore, thanks to the use of the heat exchanger, no additives are added to this second fuel. Accordingly, the cost of this second fuel is not increased and its yield is not reduced.

Thus, the fuel supply device for a heat engine according to the invention enables the use of a second fuel to feed this heat engine at a reasonable cost and with an advantageous carbon footprint for this second fuel, with a first fuel ensuring the start-up of this heat engine regardless of the temperature conditions.

The heat exchanger of the fuel supply device for a heat engine according to the invention may consist, for example, of an air/fuel exchanger that uses the air circulating around the heat engine. This air is actually heated by the heat released by the heat engine during its operation, and can then heat the second fuel that is circulating in this heat exchanger.

The heat exchanger may also consist of an air/fuel exchanger that uses the exhaust gases released by the heat engine during its operation. These exhaust gases, which are generated by the combustion of the fuel in the heat engine, are actually very hot. For example, the temperature of the exhaust gases may be on the order of 700° C. for the turbo motor of a rotary-wing aircraft. These exhaust gases may then heat the second fuel in this exchanger. An intermediate fluid may also be used, with the exhaust gases heating this intermediate fluid and with this intermediate fluid heating the second fuel.

Furthermore, the heat exchanger may also be an oil/fuel exchanger that uses oil circulating in a mechanical gearbox driven by the heat engine. This oil is heated during the operation of this mechanical gearbox and can then heat the second fuel in this heat exchanger.

Advantageously, as in all of the examples described above, the heat exchanger may use thermal energy that is available and that costs nothing. Indeed, this thermal energy is released during the operation of the heat engine or of the mechanical gearbox, and is not used.

The heat exchanger may also use electrical resistors to heat the second fuel. Such a heat exchanger requires a source of electrical energy, but may allow the second fuel to be heated when the heat engine is stopped. Consequently, the second fuel, which is heated even when the heat engine is stopped, may optionally be used to start this heat engine.

The thermal power of the heat exchanger must be sufficient to raise the temperature of the second fuel from the minimum working temperature, which is traditionally −40° C., to a temperature above 0° C., which, for example, may correspond to the gelation temperature of this second fuel, which second fuel, as mentioned above, has a high production yield. This necessary thermal power is, for example, on the order of 5 kW for a turbo motor with a power rating on the order of 500 kW. This thermal power is largely available on a rotary-wing aircraft regardless of the heating device for the second fuel, as described hereinabove.

The choice of the heat exchanger that is used in the fuel supply device for a heat engine according to the invention depends notably on the heat flux emitted by the selected heat source. Advantageously, the higher this heat flux, the smaller the heat exchanger and the lower it's mass. This choice also depends on the installation constraints and, more specifically, on the spatial volumes available in the vicinity of these sources.

Last, if this fuel supply device for a heat engine is installed on board a rotary-wing aircraft, this choice also depends on the structure of this aircraft and on the definition of its so-called “fire zones”. In fact, a fire zone is a zone within which the propagation of a fire must be contained for a given period, and the fuel can circulate on board such an aircraft only in such fire zones. Therefore, the heat exchanger must be located in one of the fire zones of the aircraft.

According to a first embodiment of the invention, the feed device includes an inlet conduit and an outlet conduit for the heat exchanger, as well as a return conduit that discharges into the second reservoir and a return valve. The inlet conduit is located between the second feed pump and the heat exchanger, while the outlet conduit is located between the heat exchanger and the second feed conduit. The return valve is located at one end of the outlet conduit, between this outlet conduit and the second feed conduit, and is connected to a return conduit. This return valve makes it possible to direct the second fuel exiting from the heat exchanger to the second feed conduit and then to the heat engine, or to the return conduit and then to the second reservoir.

This return valve is driven as a function of the temperature of the second fuel in order to direct the second fuel to the return conduit when the temperature of the second fuel is lower than or equal to a setpoint temperature Tc, and to the second feed conduit when the temperature of the second fuel is higher than this setpoint temperature Tc. Thus, when the second fuel is at a temperature that is lower than or equal to the setpoint temperature Tc, it is directed to the reservoir and then passes again through the heat exchanger in order to be heated again so as to reach a temperature that is higher than this setpoint temperature Tc. Conversely, when the second fuel is at a temperature that is higher than this setpoint temperature Tc, it is directed to the second feed conduit and then to the heat engine.

Accordingly, if, for example, the setpoint temperature Tc is higher than or equal to this gelation temperature of the second fuel, this second fuel is directed to the heat engine only if its temperature is higher than its gelation temperature, thereby eliminating any risk that the filters of this heat engine might be clogged by solidified particles of this second fuel.

The heat engine can then be fed solely by the second fuel, with this second fuel replacing the first fuel. Advantageously, the first feed pump can then be halted when the return valve directs the second fuel to the heat engine, because the first fuel is no longer feeding the heat engine.

The setpoint temperature Tc is preferably equal to the gelation temperature of the second fuel, to which a safety margin is added that makes it possible to take into consideration, on the one hand, the viscosity dispersions of the second fuel and, on the other hand, the dispersions and the uncertainties associated with the measurements of the temperature of this second fuel. This safety margin also makes it possible to ensure that the second fuel is injected into the heat engine at a temperature that is higher than this gelation temperature. This safety margin makes it possible to take into consideration the circulation of the second fuel in the various conduits leading to the heat engine, as well as the cooling that it might undergo.

For example, this safety margin may be on the order of 10° C.

According to a second embodiment of the invention, the feed device includes, as a supplement to the first embodiment, a shunt conduit and a shunt valve. This shunt valve is positioned on the inlet conduit, between the second feed pump and the heat exchanger. The shunt conduit is connected to the shunt valve and discharges into the outlet conduit. This shunt valve makes it possible to direct the second fuel exiting from the second feed pump to the heat exchanger or to the shunt conduit.

Such a shunt valve is driven as a function of the temperature of the second fuel in order to direct the second fuel coming from the second feed pump to the heat exchanger when the temperature of the second fuel is lower than or equal to the setpoint temperature Tc, and directly to the outlet conduit, by means of the shunt conduit, when the temperature of the second fuel is higher than this setpoint temperature Tc. Thus, if the second fuel is at a temperature that is lower than or equal to the setpoint temperature Tc, it is directed to the heat exchanger in order to be heated. Conversely, if the second fuel is at a temperature that is higher than the setpoint temperature Tc, it is directed to the second feed conduit, by means of the outlet conduit and the shunt conduit, and then to the heat engine.

Accordingly, this second fuel does not circulate through the heat exchanger when its temperature is higher than the setpoint temperature Tc. Advantageously, this second fuel does not undergo the load losses that are associated with the passage through this heat exchanger. Consequently, the suction capabilities of the heat engine may be sufficient to aspirate the second fuel in the second reservoir into the feed housing of the heat engine—naturally, with the return valve directing the second fuel to the second feed conduit and then to the heat engine. Advantageously, the second feed pump can then be halted.

According to a third embodiment of the invention, the feed device includes, as a supplement to the second embodiment, a feed valve positioned at a junction of the first and second feed conduits, between the first and second feed conduits and the final conduit. The feed valve is driven as a function of the temperature of the second fuel, in order to direct the first fuel coming from the first feed conduit to the final conduit, and then to the feed housing when the temperature of the second fuel is lower than or equal to the setpoint temperature Tc. The feed valve also makes it possible to direct the second fuel coming from the second feed conduit to the final conduit and then to the feed housing when the temperature of the second fuel is higher than the setpoint temperature Tc.

According to this third embodiment, the suction capabilities of the heat engine may be sufficient to aspirate the first fuel in the first reservoir into the feed housing of this heat engine without the use of a dedicated pump. In this case, the first feed pump may be formed [as a unit] with this heat engine.

Furthermore, each valve (that is, the return valve, the shunt valve, and/or the feed valve) may be a thermostatic valve that automatically directs the second fuel, as a function of its temperature, to one of the outlets of this valve.

Each valve may also be driven by a calculator that is part of the feed device, with this calculator being coupled to at least one measurement instrument of this feed device. Such a measurement device makes it possible to measure the temperature of the second fuel in the feed device. For example, a first measurement instrument may measure the temperature of the second fuel at the outlet of the heat exchanger in order to drive the return valve, and a second measurement instrument may measure the temperature of the second fuel at the outlet of the second feed pump in order to drive the shunt valve. The feed valve may be driven jointly by the first and second measurement instruments or by a third measurement instrument that measures the temperature of the second fuel in the second feed conduit.

This calculator may also drive the shutdown of the first and second feed pumps as a function of the measurements of the temperatures of the second fuel and as a function of the driving of the valves of the fuel supply device for a heat engine.

The present invention also relates to a power plant that includes:
at least one heat engine;
one feed housing for each heat engine, with the feed housing allowing the injection of fuel into the heat engine;
a mechanical gearbox driven by each heat engine; and
a feed device, as described hereinabove, in order to feed fuel to at least one heat engine.

The present invention also relates to a rotary-wing aircraft that includes at least one main rotor equipped with a plurality of blades, and that optionally includes a tail rotor. This aircraft includes a power plant, as described hereinabove, which power plant rotatively drives each rotor of the aircraft by means of the mechanical gearbox.

The present invention also relates to a procedure for feeding fuel to a heat engine, which heat engine may be fed, by means of a feed housing, by a first fuel and by a second fuel, with the first fuel being stored in a first reservoir and the second fuel being stored in a second reservoir. During this procedure for feeding fuel to a heat engine:

The first fuel is pumped into the first reservoir in order to be directed to a first feed conduit;

The second fuel is pumped into the second reservoir in order to be directed to a heat exchanger;

The second fuel is circulated in the heat exchanger in order to heat the second fuel;

The second fuel is directed to a second feed conduit; and

The feed housing and then the heat engine are fed by the first fuel or by the second fuel.

Thus, the feed housing of the heat engine may be fed, on the one hand, directly by the first fuel, and, on the other hand, by the second fuel, with this second fuel passing through the heat exchanger in order to be heated.

The first fuel should allow the operation of the heat engine regardless of the temperature conditions, whereas the second fuel must be heated before feeding this heat engine when its temperature is lower than its gelation temperature. The second fuel, after it has reached a sufficient temperature, makes it possible to feed the feed housing and then the heat engine, with this second fuel then replacing the first fuel.

The heat exchanger preferably uses part of the thermal energy that is available as a result of the operation of the heat engine.

Furthermore, the second fuel, after exiting the heat exchanger, may be caused to circulate through a return valve. Then, thanks to the return valve, the second fuel may be directed to the second reservoir when the temperature of the second fuel is lower than or equal to a setpoint temperature Tc. The second fuel may then pass through the heat exchanger again, by means of the second feed pump, in order to be heated.

Conversely, thanks to the return valve, the second fuel may be directed to the heat engine when the temperature of the second fuel is higher than the setpoint temperature Tc. Indeed, when the temperature of the second fuel is at a sufficient temperature for feeding the heat engine, it is then directed to the second feed conduit and then to the heat engine.

Furthermore, after the second fuel has been pumped, this second fuel may be caused to circulate through a shunt valve. Then, thanks to the shunt valve, the second fuel may be directed to the heat exchanger when the temperature of the second fuel is lower than or equal to the setpoint temperature Tc, and to the return valve when the temperature of the second fuel is higher than the setpoint temperature Tc.

Thus, when the second fuel is at a temperature that is higher than this setpoint temperature Tc, it does not circulate through the heat exchanger, and instead is directed, via the return valve, directly to the second feed conduit and then to the heat engine. The second fuel thus undergoes fewer load losses before reaching the feed housing.

Conversely, if the second fuel is at a temperature that is lower than or equal to the setpoint temperature Tc, it is directed to the heat exchanger in order to be heated.

Last, the first and second fuels may be caused to circulate through a feed valve before feeding the heat engine. Then, thanks to this feed valve, the first fuel may be directed to the heat engine when the temperature of the second fuel is lower than or equal to the setpoint temperature Tc, or the second fuel may be directed to the heat engine when temperature of the second fuel is higher than the setpoint temperature Tc.

### BRIEF DESCRIPTION OF THE SEVERAL VIEWS OF THE DRAWINGS

The invention and its advantages will be made clear in greater detail within the scope of the following description, with examples of embodiments that are provided for illustrative purposes, with reference to the attached drawings, on which:

FIG. 1 shows an aircraft equipped with a power plant that includes a fuel supply device for a heat engine according to the invention; and

FIGS. 2 through 4 show three power plants that include three embodiments of this fuel supply device for a heat engine.

### DETAILED DESCRIPTION OF THE INVENTION

The elements that are present in multiple different figures have been assigned the same individual reference numbers.

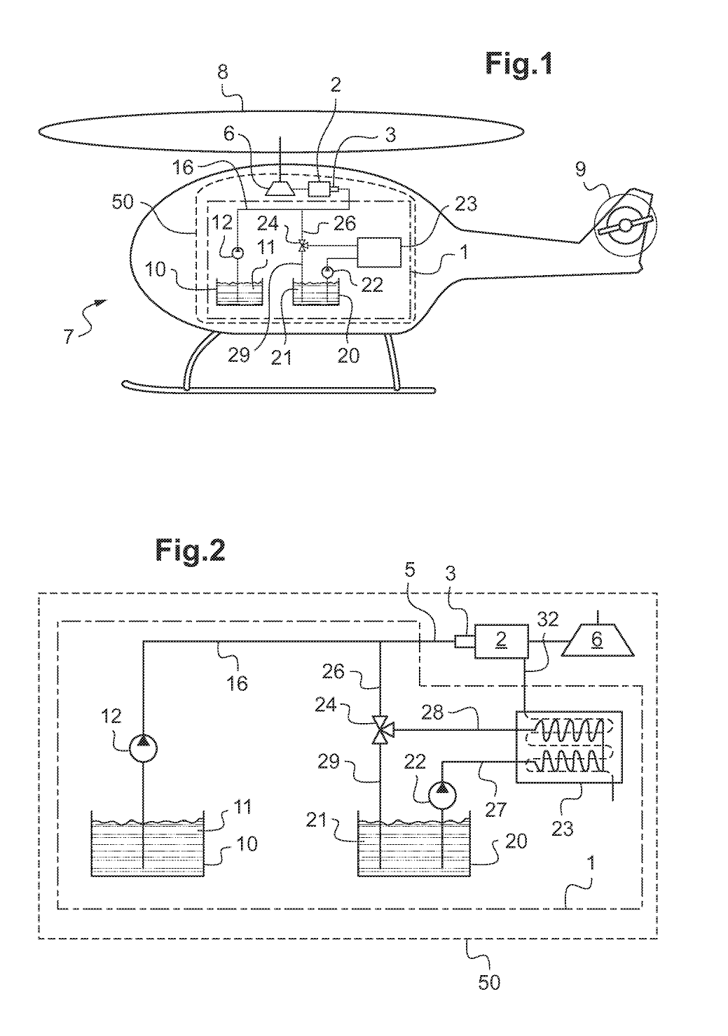

FIG. 1 shows a rotary-wing aircraft 7 that includes a power plant 50 and a main rotor 8 equipped with a plurality of blades, and that also includes a tail rotor 9. This power plant includes:
a heat engine 2;
a feed housing 3 connected to the heat engine 2, with the feed housing 3 allowing the injection of fuel into the heat engine 2;
a mechanical gearbox 6 driven by the heat engine 2 and driving the main rotor 8 and the tail rotor 9; and
a fuel supply device 1 for the heat engine 2.

This power plant 50 rotatively drives the main rotor 8 and the tail rotor 9 by means of the mechanical gearbox 6.

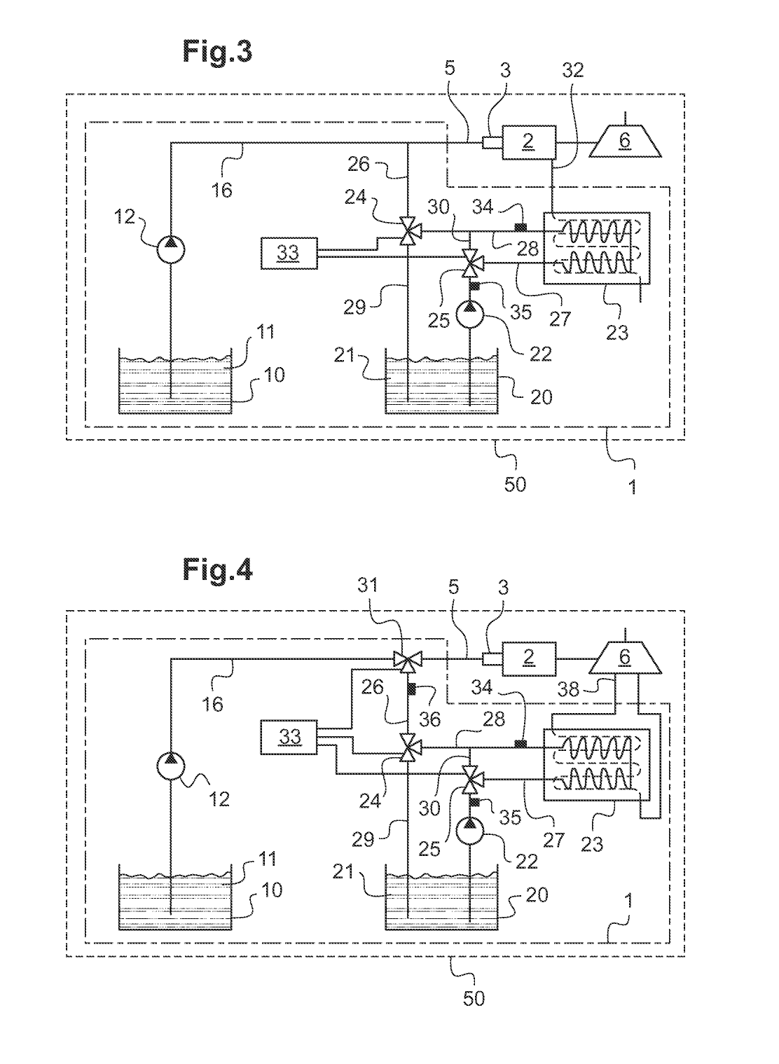

FIGS. 2 through 4 show three power plants 50 that include different embodiments of the fuel supply device 1 for the heat engine 2.

In a shared manner, each fuel supply device 1 for the heat engine 2 includes:

Two reservoirs 10, 20, with a first reservoir 10 containing a first fuel 11 and a second reservoir 20 containing a second fuel 21;

Two feed pumps 12, 22;

Two feed conduits 16, 26;

A final conduit 5;

A heat exchanger 23;

An inlet conduit 27 and an outlet conduit 28; and

A return valve 24.

The first fuel 11 is directed from the first reservoir 10 to the first feed conduit 16 by means of the first feed pump 12. The second fuel 21 is directed from the second reservoir 20 to the heat exchanger 23 by means of the second feed pump 22. The second fuel 21 enters the heat exchanger 23 via the inlet conduit 27 and exits the heat exchanger 23 via the outlet conduit 28 after having been heated by passing through this heat exchanger 23. The second fuel can then be directed to the second feed conduit 26.

The first feed conduit 16 and the second feed conduit 26 are rejoined ahead of the feed housing 3 in order to form the final conduit 5 that feeds this feed housing and then the heat engine 2.

Thus, on the one hand, the feed housing 3 of the heat engine 2 may be fed, through this final conduit 5, directly by the first fuel 11; on the other hand, it may be fed by the second fuel 21, which was previously heated by passing through the heat exchanger 23.

The first fuel 11 has a very low gelation temperature (for example, lower than or equal to −40° C.) and serves as a start-up fuel for the heat engine 2. This first fuel 11 allows the heat engine 2 to operate at temperatures falling as far as −40° C.

The second fuel 21 has a gelation temperature that is higher than [that of] the first fuel 11 (for example, on the order of 0° C.). The second fuel 21 may be a biofuel obtained, for example, from biomass, such as algae. Its use makes it possible, on the one hand, to reduce pollutant emissions, and, on the other hand, to reduce the overall carbon footprint of this heat engine during its operation.

The second fuel 21 may also be an alternative fuel based on coal or natural gas.

After the second fuel 21 has reached a temperature that is higher than its gelation temperature, it may be used to feed the heat engine 2 with no risk of gelation, thereby also eliminating any risk that the filters of this heat engine 2 might be clogged by solidified particles of this second fuel 21. The second fuel 21 then replaces the first fuel 11 in order to feed the heat engine 2.

The feed device 1 includes a return valve 24 and a return conduit 29. This return valve 24 is positioned at one end of the outlet conduit 28 and makes it possible to direct the second fuel 21 exiting from the heat exchanger 23 depending on the temperature of this second fuel 21. Thus, when the temperature of the second fuel 21 is lower than or equal to a setpoint temperature Tc, the second fuel 21 is directed to the return conduit 29, and when the temperature of the second fuel 21 is higher than this setpoint temperature Tc, the second fuel 21 is directed to the second feed conduit 26 and then to the heat engine 2. The return conduit 29 allows the second fuel 21 to return to the second reservoir 20 in order to pass again through the heat exchanger 23 in order to be heated again.

Accordingly, because the setpoint temperature Tc is higher than the gelation temperature of the second fuel 21, this second fuel 21 is directed to the heat engine 2 only when its temperature is higher than its gelation temperature. The heat engine 2 is then fed solely by the second fuel 21. The first feed pump 12 can then be halted in order to stop the feeding of the heat engine 2 by the first fuel 11.

In a first embodiment of the invention, shown in FIG. 2, this return valve 24 is a thermostatic valve that, depending on the temperature of the second fuel 21, automatically directs the second fuel 21 to the second feed conduit 26 or to the return conduit 29.

The second embodiment of the invention, shown in FIG. 3, is a variant of the first embodiment. In addition to the return valve 24, it includes a shunt valve 25 and a shunt conduit 30. This shunt valve 25 is positioned on the inlet conduit 27, between the second feed pump 22 and the heat exchanger 23. The shunt conduit 30 is positioned between this shunt valve 25 and the outlet conduit 28.

This shunt valve 25 makes it possible to direct the second fuel 21 exiting from the second feed pump 22 according to the temperature of this second fuel 21. Thus, when the temperature of the second fuel 21 is lower than or equal to the setpoint temperature Tc, the second fuel 21 is directed to the heat exchanger 23, and when the temperature of the second fuel 21 is higher than this setpoint temperature Tc, the second fuel 21 is directed to the shunt conduit 30 and then to the return valve 24. Because the temperature of the second fuel 21 is higher than this setpoint temperature Tc, the return valve 24 makes it possible to direct the second fuel 21 to the second feed conduit 26 and then to the heat engine 2.

Accordingly, because the setpoint temperature Tc is higher than the gelation temperature of the second fuel 21, this second fuel 21 is directed to the heat exchanger 23, in order to be heated, only when its temperature is lower than or equal to its gelation temperature. Conversely, if the temperature of the second fuel 21 is higher than its gelation temperature, the second fuel 21 is directed to the outlet conduit 28, by means of the shunt conduit 30, and then to the heat engine 2.

When the second fuel 21 does not circulate through the heat exchanger 23, it does not undergo the load losses that are associated with the passage through this heat exchanger 23. Consequently, the suction capabilities of the heat engine 2 may be sufficient to allow the second feed pump 22 to be halted.

According to this second embodiment, the feed device 1 also includes a calculator 33 and two measurement instruments 34, 35. These measurement instruments 34, 35 make it possible to measure the temperature of the second fuel 21 in the feed device 1, with a first measurement instrument 34 measuring this temperature at the outlet of the heat exchanger 23 and with a second measurement instrument 35 measuring this temperature at the outlet of the second feed pump 22. The calculator 33 is coupled to the measurement instruments 34, 35, and therefore can drive the return valve 24 and the shunt valve 25 in order to direct the second fuel 21. This calculator may also drive the shutdown of the feed pumps 12, 22.

The third embodiment of the invention, shown in FIG. 4, is a variant of the second embodiment. In addition to the return valve 24 and the shunt valve 25, it includes a feed valve 31. This feed valve 31 is positioned at a junction of the first and second feed conduits 16, 26, and makes it possible to direct the first fuel 11 or the second fuel 21 to the final conduit 5 and then to the heat engine 2, depending on the temperature of this second fuel 21. Thus, when the temperature of the second fuel 21 is lower than or equal to the setpoint temperature Tc, the first fuel 11, coming from the first feed conduit 16, is directed to the heat engine 2 via the final conduit 5 and the feed housing 3. Conversely, when the temperature of the second fuel 21 is higher than this setpoint temperature Tc, the second fuel 21, coming from the second feed conduit 26, is directed to the heat engine 2 via the final conduit 5 and the feed housing 3.

According to this third embodiment, the feed device 1 also includes a calculator 33 and three measurement instruments 34, 35, 36, with a first measurement instrument 34 measuring the temperature of the second fuel 21 at the outlet of the heat exchanger 23; a second measurement instrument 35 measuring this temperature at the outlet of the second feed pump 22; and a third measurement instrument 36 measuring this temperature in the second feed conduit 26. The calculator 33 is coupled to the measurement instruments 34,36 and can therefore drive the return valve 24, the feed valve 31, and the shutdown of the feed pumps 12, 22.

For this third embodiment, the suction capabilities of the heat engine 2 may make it possible to aspirate the first fuel 11 in the first reservoir 10 without the use of a dedicated pump. In this case, the first feed pump 12 may be formed by the heat engine 2.

Furthermore, the heat exchanger 23 uses part of the thermal energy that is available as a result of the operation of the heat engine 2.

According to the first and second embodiments, shown respectively in FIG. 2 and FIG. 3, the heat exchanger 23 is an air/fuel exchanger that uses the air circulating around the heat engine 2. This air is heated by the heat released by the heat engine 2 during its operation and is directed to the heat exchanger 23 by the first transfer conduit 32. This air can then heat the second fuel 21 when it passes through this heat exchanger 23.

According to the third embodiment, shown in FIG. 4, the heat exchanger 23 is an oil/fuel exchanger that uses oil circulating in the mechanical gearbox 6 driven by the heat engine 2. This oil is heated during the operation of this mechanical gearbox 6 and is then directed to the heat exchanger 23 by the second transfer conduit 38. This air can then heat the second fuel 21 in this heat exchanger 23.

Advantageously, these two types of heat exchangers 23 use thermal energy that is available and that costs nothing. Indeed, this thermal energy is released during the operation of the heat engine 2 or of the mechanical gearbox 6, and is not used.

Furthermore, the heat exchanger 23 may also be an air/fuel exchanger that uses the exhaust gases released by the heat engine 2 during its operation.

Moreover, the heat exchanger 23 may also use electrical resistors to heat the second fuel. Therefore, this heat exchanger 23 would require a source of electrical energy.

Naturally, the present invention is subject to numerous variations in terms of its implementation. Although several embodiments have been described, it will be readily understood that an exhaustive identification of all of the possible arguments is inconceivable. Of course, any of the means that have been described may be replaced by equivalent means without departing from the scope of the present invention.

What is claimed is:

1. A fuel supply device for a heat engine, which feed device includes two reservoirs, two feed pumps and two feed conduits, a first reservoir containing a first fuel and a second reservoir containing a second fuel, with the first and second reservoirs being in communication with a feed housing of the heat engine by means respectively of first and second feed conduits, with a first feed pump being positioned between the first reservoir and the first feed conduit and a second feed pump being positioned between the second reservoir and the second feed conduit, with the feed device also including a heat exchanger located between the second feed pump and the second feed conduit, so as to heat the second fuel before reaching the second feed conduit, as well as an outlet conduit located between the heat exchanger and the second feed conduit, and a return valve positioned between the outlet conduit and the second feed conduit and connected to a return conduit discharging into the second reservoir, with the return valve being driven as a function of the temperature of the second fuel in order to direct the second fuel to the return conduit when the temperature of the second fuel is lower than or equal to a setpoint temperature Tc, and to the second feed conduit when the temperature of the second fuel is higher than the setpoint temperature Tc, wherein:
the feed device includes an inlet conduit located between the second feed pump and the heat exchanger, as well as a shunt valve located on the inlet conduit and connected to a shunt conduit, with the shunt conduit discharging into the outlet conduit, with the shunt valve being driven as a function of the temperature of the second fuel in order to direct the second fuel coming from the second feed pump to the heat exchanger when the temperature of the second fuel is lower than or equal to the setpoint temperature Tc, and to the shunt conduit when the temperature of the second fuel is higher than the setpoint temperature Tc.

2. The feed device according to claim 1, wherein the feed device includes a feed valve positioned at a junction of the first and second feed conduits, with the feed valve being driven as a function of the temperature of the second fuel in order to direct the first fuel coming from the first feed conduit to the feed housing when the temperature of the second fuel is lower than or equal to the setpoint temperature Tc, and to direct the second fuel coming from the second feed conduit to the feed housing when the temperature of the second fuel is higher than the setpoint temperature Tc.

3. The feed device according to claim 1, wherein each valve may be a thermostatic valve that automatically directs the second fuel as a function of the temperature of the second fuel.

4. The feed device according to claim 1, wherein the feed device includes a calculator and at least one measurement instrument measuring the temperature of the second fuel in the feed device, with each valve being able to be driven by the calculator and with the calculator being coupled to each measurement instrument.

5. The feed device according to claim 1, wherein the setpoint temperature Tc is higher than or equal to the gelation temperature of the second fuel.

6. The feed device according to claim 1, wherein the second fuel has a gelation temperature that is higher than the first fuel.

7. The feed device according to claim 6, wherein the first fuel is a fuel that has a gelation temperature that is lower than or equal to −40° C., whereas the second fuel is a fuel that has a gelation temperature that is higher than or equal to 0° C.

8. The feed device according to claim 1, wherein the second fuel is a biofuel.

9. A power plant that includes:
at least one heat engine;
one feed housing for each heat engine, with the feed housing allowing the injection of fuel into the heat engine; and
a mechanical gearbox driven by each heat engine;
wherein the power plant includes at least one feed device to feed fuel to at least one heat engine, with the feed device being in accordance with claim 1.

10. The power plant according to claim 9, wherein the heat exchanger uses oil circulating in the mechanical gearbox to heat the second fuel.

11. A power plant according to claim 9, wherein the heat exchanger uses air circulating around at least one heat engine to heat the second fuel.

12. A power plant according to claim 9, wherein the heat exchanger uses exhaust gases from at least one heat engine to heat the second fuel.

13. A power plant according to claim 12, wherein the heat exchanger uses an intermediate fluid heated by the exhaust gases from at least one heat engine to heat the second fuel.

14. A power plant according to claim 9, wherein the heat exchanger uses electrical resistors to heat the second fuel.

15. A rotary-wing aircraft, including at least one main rotor equipped with a plurality of blades, wherein the aircraft includes a power plant according to claim 9, with the power plant rotatively driving each main rotor by means of the mechanical gearbox.

16. A procedure for feeding fuel to a heat engine, with the heat engine being able to be fed by a first fuel and by a second fuel, with the first fuel being stored in a first reservoir and with the second fuel being stored in a second reservoir, during which procedure:
the first fuel is pumped into the first reservoir in order to be directed to a first feed conduit;
the second fuel is pumped into the second reservoir in order to be directed to a shunt valve;
thanks to the shunt valve, the second fuel is directed to a heat exchanger when the temperature of the second fuel is lower than or equal to a setpoint temperature Tc, with the second fuel then circulating in the heat exchanger in order to heat the second fuel, and then being directed to a return valve, and directly to the return valve when the temperature of the second fuel is higher than the setpoint temperature Tc;
thanks to the return valve, the second fuel is directed to the second reservoir when the temperature of the second fuel is lower than or equal to a setpoint temperature Tc, and to the heat engine via a second feed conduit when the temperature of the second fuel is higher than the setpoint temperature Tc;
the first and second fuels are circulated in a feed valve;
thanks to the feed valve, the first fuel coming from the first feed conduit to the heat engine when the temperature of the second fuel is lower than or equal to the setpoint temperature Tc, and the second fuel coming from the second feed conduit is directed to the heat engine when the temperature of the second fuel is higher than the setpoint temperature Tc; and
the heat engine is fed by the first fuel or else by the second fuel.
